(19) United States
(12) Patent Application Publication
(10) Pub. No.: US 2017/0210312 A1
(43) Pub. Date: Jul. 27, 2017

(54) ON-BOARD ELECTRICAL SYSTEM FOR A VEHICLE

(71) Applicant: Eberspächer Controls Landau GmbH & Co. KG, Landau (DE)

(72) Inventors: Steffen WANDRES, Kandel (DE); Dirk MANDERY, Niederschlettenbach (DE)

(21) Appl. No.: 15/411,160

(22) Filed: Jan. 20, 2017

(30) Foreign Application Priority Data
Jan. 22, 2016 (DE) 10 2016 101 081.2

(51) Int. Cl. B60R 16/033; H01M 10/06; H01M 10/0525

(52) U.S. Cl. CPC B60R 16/033; H01M 10/0525; H01M 10/06; H01M 2220/20

(57) ABSTRACT

An on-board electrical system for a vehicle includes a first rechargeable constant voltage source (12), a second rechargeable constant voltage source (14), and a circuit breaker device (16) therebetween, including a first circuit breaker (18) and a second circuit breaker (20). Each circuit breaker (18, 20) permits current flow between input terminal (E1, E2) and output terminals (A1, A2) in both directions in a conductor state and permits current flow from the input terminal (E1, E2) to the output terminal (A1, A2) only in a diode state. The input terminal (E1) of the first circuit breaker (18) is connected to the first constant voltage source (12), the output terminal (A1) of the first circuit breaker (18) is connected to the output terminal (A2) of the second circuit breaker (20), and the output terminal (A2) of the second circuit breaker (20) is connected to the second constant voltage source (14).

### CROSS REFERENCE TO RELATED APPLICATIONS

This application claims the benefit of priority under 35 U.S.C. §119 of German Application DE 10 2016 101 081.2 filed Jan. 22, 2016, the entire contents of which are incorporated herein by reference.

### FIELD OF THE INVENTION

The present invention pertains to an on-board electrical system for a vehicle, in which a great variety of consumers of electrical energy can be supplied.

### BACKGROUND OF THE INVENTION

An electronic circuit breaker for an on-board electrical system of a motor vehicle, which is switched between an energy storage device connected to an alternator and a starter and a second energy storage device connected to the consumers of electrical energy in an on-board electrical system, is known from EP 2 017 935 A2. This electronic circuit breaker has an input terminal connected to the first energy storage device and an output terminal connected to the second energy storage device as well as a terminal for a control voltage and can establish, in principle, a conductive connection between the two energy storage devices or even between the alternator and the electrical energy consumers. If load peaks occur, which lead to a great voltage drop in the area of the first energy storage device and hence to a current flow from the second energy storage device to the first energy storage device, the circuit breaker is opened, so that a voltage drop is avoided in the area of the part of the on-board electrical system being supplied by the second energy storage device.

Electrical energy consumers that may cause very high loads of the on-board electrical system during short time periods are increasingly used in modern vehicles. These are, for example, the electric motors of electrical steering assist systems, which are used for automatic parking operations. To make it possible to guarantee sufficient stability of the voltage provided in the on-board electrical system even under such high loads on the on-board electrical system, for example, lithium ion batteries are used, which have a markedly lower internal resistance than the lead storage batteries used conventionally. However, such lithium ion batteries have a poor cold start ability at comparatively low ambient temperatures, so that it is necessary to also integrate lead storage batteries in such on-board electrical systems especially in order to guarantee reliable start characteristics as low temperatures as well.

The parallel connection of lead storage batteries and lithium ion batteries is associated, in principle, with the problem that these batteries have different no-load voltages. The no-load voltage level of lithium ion batteries is, in general, above the no-load voltage level of lead storage batteries. To compensate this and to avoid an excessive discharge of the lithium ion batteries as well as excessive charging of the lead storage batteries, a d.c.-d.c. converter may be inserted between these batteries in order to equalize the voltage levels of the two batteries. Such systems have limited performance capacity and are comparatively cost-intensive.

### SUMMARY OF THE INVENTION

An object of the present invention is to provide an on-board electrical system for a vehicle, which has a simple and operationally reliable configuration and offers reliable power supply.

This object is accomplished according to the present invention by an on-board electrical system for a vehicle, comprising:
a first rechargeable constant voltage source,
a second rechargeable constant voltage source,
a circuit breaker device connected between the first constant voltage source and the second constant voltage source with a first circuit breaker and with a second circuit breaker, wherein each circuit breaker permits the flow of current between its input terminal and its output terminal in both directions and permits the flow of current only from the input terminal to the output terminal in its diode state, wherein the input terminal of the first circuit breaker is connected to the first constant voltage source, the output terminal of the first circuit breaker is connected to the output terminal of the second circuit breaker and the output terminal of the second circuit breaker is connected to the second constant voltage source.

The use of two circuit breakers, which can each be switched over between a conductor state and a diode state, makes it possible to couple the two constant voltage sources into the on-board electrical system and to connect it to other system areas of the on-board electrical system in a great variety of operating states such that reliable supply of electrical energy consumers is guaranteed even at a high load and at low ambient temperatures, on the one hand, but a mutually harmful interaction of the two constant voltage sources is avoided, on the other hand.

To make it possible to provide a reliable cold start ability in the on-board electrical system, the first constant voltage source may be a lead storage battery. Further, to stabilize the on-board electrical system especially at high load, the second constant voltage source may be a lithium ion battery.

To make it possible to use the first constant voltage source, which is preferably configured as a lead storage battery in the starting operation for supplying a starter without disadvantageous interaction with the second constant voltage source or with different consumers, the starter may be connected to the first constant voltage source and to the input terminal of the first circuit breaker.

Provisions may be made in a variant that is especially advantageous for the reliability of operation of the on-board electrical system according to the present invention for an alternator to be connected to the output terminal of the first circuit breaker and to the output terminal of the second circuit breaker. Further, provisions are advantageously made now for a first group of electrical energy consumers to be connected to the output terminal of the first circuit breaker and to the output terminal of the second circuit breaker. This first group of electrical energy consumers may comprise, for example, safety-relevant systems of a vehicle, for example, a brake system. It is guaranteed due to the integration of these consumers in the on-board electrical system according to the present invention that these can be supplied by both the two constant voltage sources and the alternator.

A second group of electrical energy consumers may be connected to the second constant voltage source and to the input terminal of the second circuit breaker. This second group of electrical energy consumers may comprise consumers that cause a high load on the on-board electrical system due to high operating currents during the operation.

To make it possible to switch the two circuit breakers between their two operating states, i.e., the conductor state and the diode state, an actuating device may be provided, which is configured
to switch the first circuit breaker into its diode state in a starter operating state for starting an internal combustion engine, or/and
to switch the first circuit breaker into its diode state in a parking operating state, or/and
to switch the first circuit breaker into its conductor state in a charging operating state for the first constant voltage source and to switch the second circuit breaker into its diode state, or/and
to switch the first circuit breaker into its diode state when the first constant voltage source reaches a predetermined state of charge, or/and
to switch the second circuit breaker into its diode state when the voltage on the output terminal of the first circuit breaker or/and on the output terminal of the second circuit breaker or/and on the input terminal of the second circuit breaker drops below a predetermined threshold voltage, or/and
to switch the first circuit breaker into its diode state and the second circuit breaker into its conductor state in a power supply operating state.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic system view showing the configuration of an on-board electrical system for a vehicle with two rechargeable constant voltage sources and with a plurality of electrical energy consumers.

### DESCRIPTION OF THE PREFERRED EMBODIMENTS

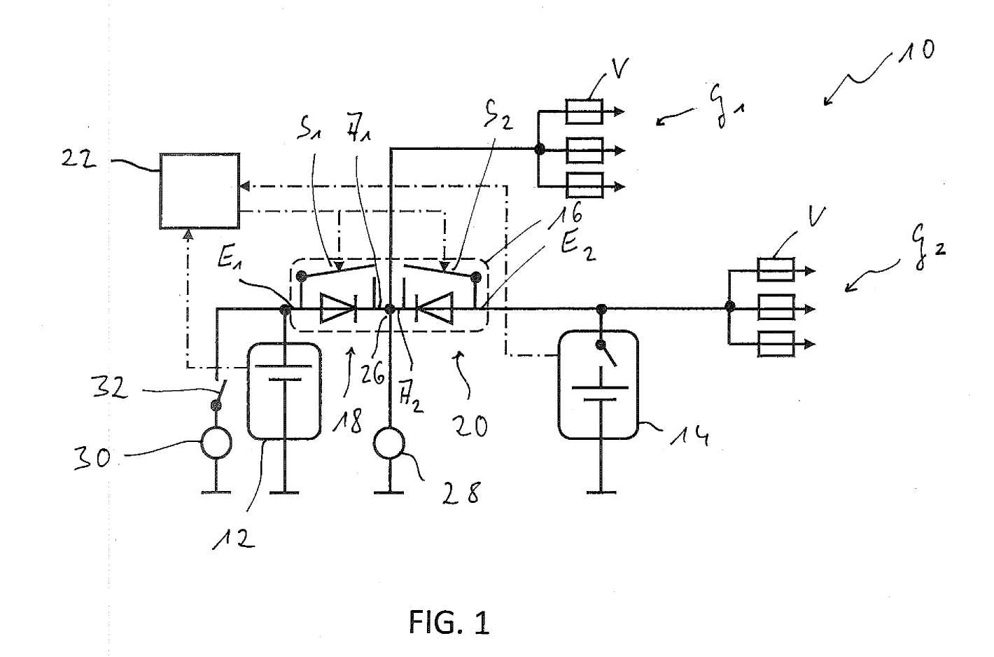

Referring to the drawings, the on-board electrical system 10 shown in FIG. 1 comprises as essential components a first rechargeable constant voltage source 12, configured, for example, as a lead storage battery, and a second rechargeable constant voltage source 14, configured, for example, as a lithium ion battery. The on-board electrical system 10 further comprises a circuit breaker device 16, which is inserted between the two constant voltage sources 12, 14, especially the two + (positive) poles thereof.

The circuit breaker device 16 comprises two circuit breakers 18, 20, which may have, e.g., the configuration of the electronic circuit breakers known from, e.g., EP 2 017 935 A2. Such circuit breakers are commercially available from the applicant under the trade name Q diode (quasi diode). The configuration and the functionality of each of these two circuit breakers 18, 20 can be described, in principle, such that each has a respective input terminal E1 and E2 and a respective output terminal A1 and A2. Further, each of the circuit breakers 18, 20 has a respective control terminal S1 and S2, via which a control voltage provided by an actuating device 22 can be applied. The two circuit breakers 18, 20 can thus be switched between a diode state and a conductor state by applying a corresponding control voltage to the respective control terminal S1 and S2. The circuit breakers 18, 20 behave essentially as ideal diodes in the diode state, i.e., they only permit the flow of current from the respective input terminal E1 and E2 to the respective output terminal A1 and A2, assuming a corresponding potential difference between the respective input terminal and respective output terminal. The circuit breakers 18, 20 behave essentially as conventional low-ohmic electrical conductors in the conductor state, i.e., they permit the flow of current in both directions between the input terminal E1, E2 and the output terminal A1, A2, again assuming a corresponding potential difference.

FIG. 1 shows that the first circuit breaker 18 in the circuit breaker device 16 is connected by its input terminal E1 to the first constant voltage source 12 or the +pole thereof. The second circuit breaker 20 is likewise connected by its input terminal E2 to the second constant voltage source 14 or the +pole thereof The two output terminals A1 and A2 of the circuit breakers 18, 20 are connected to one another at a connection node 26. A preferably controllable or regulatable alternator 28 is also connected to this connection node 26 of the circuit breaker device 16. The alternator 28 is configured to generate a voltage, whose level can be regulated, and to apply same to the nodal point 26 during the operation of an internal combustion engine or in the energy recovery operation.

Further, a first group G1 of electrical energy consumers V is connected to the nodal point 26 of the circuit breaker device 16. This first group G1 also includes consumers, whose correct functionality is relevant for safety. For example, these consumers may include the brake system of a vehicle. Other electrical energy consumers., e.g., control devices and the like, may also be assigned to this first group G1.

A second group G2 of electrical energy consumers V is connected to the input terminal E2 of the second circuit breaker 20 and hence also to the second constant voltage source 14, especially to the +pole thereof The consumers V of the second group G2 are preferably consumers that generate a high load on the on-board electrical system 10 during the operation. These may be, for example, drive motors for an electrical steering assist system, a pressure pump, a vacuum pump or the like.

A starter 30 to be used to start an internal combustion engine is connected to the input terminal E1 of the first circuit breaker 18 and hence also to the first constant voltage source 12 or the +pole thereof via a switch 32 associated with said starter.

The actuating device 22 receives, among other things, information on the state of charge of the two constant voltage sources 12, 14. Further, the actuating device 22 is provided and configured for applying the control voltage to be applied for switching over the circuit breakers 18, 20 to the respective control terminals S1 and S2. For example, the actuating device 22 may be structurally or/and functionally at least partially integrated in an engine control device and may be networked with other system areas of a vehicle providing information relevant for the operation via a data bank system.

The on-board electrical system shown in FIG. 1 makes it possible to guarantee reliable operation in different operating states due to the functionality and the manner of integration of the two circuit breakers 18, 20, on the one hand, and to avoid a disadvantageous mutual influence of the two constant voltage sources 12, 14 on one another, on the other hand, especially if these are configured as a lead storage battery, on the one hand, and as a lithium ion battery, on the other hand. This will be explained below with reference to different operating states occurring in a vehicle or in such an on-board electrical system 10.

In a start operating state, i.e., for starting an internal combustion engine, the first circuit breaker 18 is switched by corresponding actuation by means of the actuating device 20 into its diode state. The switch 32 can be closed and the starter 32 can thus be operated for starting an internal combustion engine. A flow of current from the first constant voltage source 12, i.e., for example, a lead storage battery, to the second constant voltage source 14, i.e., for example, a lithium ion battery, is not possible in this state, even if the second circuit breaker 20 is being operated in its diode state. On the other hand, the second constant voltage source 14 is uncoupled by the first circuit breaker 18 being operated in the diode state from the first constant voltage source 12 and hence also from the starter 32, so that it is guaranteed that the starter 32 is supplied exclusively from the first constant voltage source 12 in this starter operating state. The consumers V of the two groups G1, G2, which consumers are present in the on-board electrical system 10, are supplied directly by the second constant voltage source 14 in case of group G2, if these consumers are to be operated at all in the starter operating mode, and they are supplied by the second constant voltage source 14, optionally already also by the alternator 28 via the nodal point 26 in case of group G1 via the second circuit breaker 20 being operated in the diode state.

The first circuit breaker 18 is advantageously also in its diode state in a parking operating state, i.e., with the internal combustion engine not operating and with the vehicle parked. The first constant voltage source 12 can thus be uncoupled from the rest of the system area of the on-board electrical system 10, and this first constant voltage source 12 can be prevented from being overloaded by leakage current from the second constant voltage source 14 or from being loaded by the no-load current.

The first circuit breaker 18 is in its conductor state in a charging operating state for the first constant voltage source 12, i.e., for example, during the operation or in the drive mode of a vehicle, so that the first constant voltage source 12 can be charged by means of the charging voltage generated by the alternator 28. Since this charging voltage is present at the nodal point 26, the consumers V of the first group G1 can also be supplied by the alternator 28. The consumers V of the second group G2 are supplied exclusively from the second constant voltage source 14 in this state, in which the second circuit breaker 20 is preferably in its diode state.

If the first constant voltage source 12 reaches a sufficient, predetermined state of charge or a predetermined charging voltage, the first circuit breaker 18 is switched into its diode state. Further charging by the alternator 28 is no longer possible thereafter because the first circuit breaker 18 is also now switched as a diode, i.e., as a blocking switch. However, the alternator 28 preferably continues to be operated such that it provides a supply voltage present at the nodal point 26 especially for the consumers V of the first group G1. The second circuit breaker 20 is preferably switched into its conductor state in this normal power supply operating state, as it may occur during the normal travel of a vehicle. This makes it possible to charge the second constant voltage source 14 by the alternator 28 if necessary. Further, both constant voltage sources 12, 14 and the alternator 28 may act in this state as a power supply for the different consumers V of the two groups G1, G2.

Connecting the first group G1, which especially also includes safety-relevant consumers V, in the nodal point 26 to the two output terminals A1, A2 of the circuit breakers 18, 20 is especially advantageous in the on-board electrical system 10 shown in FIG. 1. Since the alternator 28 is also connected to this area, it is thus guaranteed that each of the three available power sources, namely, the two power sources 12, 14 and the alternator 28, can be used to supply these consumers V of the first group G1, doing so independently from the switching state of the two circuit breakers 18, 20. Consequently, should an error occur in the switching characteristics or in the actuation of the two circuit breakers 8, 20, this cannot cause one of the power sources not to be able to be used any more for supplying the consumers V of the first group G1.

The above-described configuration of the on-board electrical system makes it possible, especially due to the use of the two circuit breakers and due to the functionality of these circuit breakers, to supply the different electrical energy consumers present in a vehicle and coupled with the on-board electrical system by means of the different power sources available in an optimal manner with a comparatively simple and cost-effective configuration. The available voltage can thus be prevented from dropping excessively in case of high load on the on-board electrical system due to the consumers, because the second constant voltage source, preferably configured as a lithium ion battery, ensures stabilization of the on-board electrical system at high load. Due to the first constant voltage source, preferably configured as a lead storage battery, being connected to the stator, it is guaranteed that an internal combustion engine can also be started under unfavorable climatic conditions without loading the second constant voltage source.

The coupling together of all three constant voltage sources via the two circuit breakers of the circuit breaker device guarantees that especially safety-relevant electrical energy consumers can be supplied at any time at least by one of the power sources.

While specific embodiments of the invention have been shown and described in detail to illustrate the application of the principles of the invention, it will be understood that the invention may be embodied otherwise without departing from such principles.

What is claimed is:

1. An on-board electrical system for a vehicle, the electrical system comprising:
a first rechargeable constant voltage source;
a second rechargeable constant voltage source;
a circuit breaker device between the first constant voltage source and the second constant voltage source, the circuit breaker device comprising a first circuit breaker with a first breaker input terminal and a first breaker output terminal, the first circuit breaker permitting a flow of current between the first breaker input terminal and the first breaker output terminal in a first breaker conductor state and permitting only a flow of current from the first breaker input terminal to the first breaker output terminal in a first breaker diode state and a second circuit breaker with a second breaker input terminal and a second breaker output terminal, the second circuit breaker permitting a flow of current between the second breaker input terminal and the second breaker output terminal in a second breaker conductor state and permitting only a flow of current from the second breaker input terminal to the second breaker output terminal in a second breaker diode state, wherein the first breaker input terminal is connected to the first constant voltage source, the first breaker output terminal is connected to the second breaker output terminal, and the second breaker output terminal is connected to the second constant voltage source.

2. An on-board electrical system in accordance with claim 1, wherein:
the first constant voltage source is a lead storage battery; or
the second constant voltage source is a lithium ion battery; or
the first constant voltage source is a lead storage battery and the second constant voltage source is a lithium ion battery.

3. An on-board electrical system in accordance with claim 1, further comprising a starter connected to the first constant voltage source and connected to the first breaker input terminal.

4. An on-board electrical system in accordance with claim 1, further comprising an alternator connected to the output terminal of the first circuit breaker and connected to the output terminal of the second circuit breaker.

5. An on-board electrical system in accordance with claim 1, further comprising a group of electrical energy consumers connected to the output terminal of the first circuit breaker and connected to the output terminal of the second circuit breaker.

6. An on-board electrical system in accordance with claim 1, further comprising a group of electrical energy consumers connected to the second constant voltage source and to the input terminal of the second circuit breaker.

7. An on-board electrical system in accordance with claim 1, further comprising:
a first group of electrical energy consumers connected to the output terminal of the first circuit breaker and connected to the output terminal of the second circuit breaker; and
a second group of electrical energy consumers connected to the second constant voltage source and to the input terminal of the second circuit breaker.

8. An on-board electrical system in accordance with claim 1, further comprising an actuating device switching over the first circuit breaker and the second circuit breaker between the conductor state and the diode state, said actuating device being configured:
to switch the first circuit breaker into the diode state thereof in a starter operating state for starting an internal combustion engine; or
to switch the first circuit breaker into the diode state thereof in a parking operating state; Or
to switch the first circuit breaker into the conductor state thereof and the second circuit breaker into the diode state thereof in a charging operating state for the first constant voltage source; or
to switch the first circuit breaker into the diode state thereof when the first constant voltage source reaches a predetermined state of charge; or
to switch the second circuit breaker into the diode state thereof when the voltage on the output terminal of the second circuit breaker or on the input terminal of the second circuit breaker drops below a predetermined threshold voltage; or
to switch the second circuit breaker into the diode state thereof when the voltage on the output terminal of the second circuit breaker and on the input terminal of the second circuit breaker drops below a predetermined threshold voltage; or
to switch the first circuit breaker into the diode state thereof and the second circuit breaker into the conductor state thereof in a power supply operating state; or
any combination of:
to switch the first circuit breaker into the diode state thereof in a starter operating state for starting an internal combustion engine; and
to switch the first circuit breaker into the diode state thereof in a parking operating state; and
to switch the first circuit breaker into the conductor state thereof and the second circuit breaker into the diode state thereof in a charging operating state for the first constant voltage source; and
to switch the first circuit breaker into the diode state thereof when the first constant voltage source reaches a predetermined state of charge; and
to switch the second circuit breaker into the diode state thereof when the voltage on the output terminal of the second circuit breaker or on the input terminal of the second circuit breaker drops below a predetermined threshold voltage; and
to switch the second circuit breaker into the diode state thereof when the voltage on the output terminal of the second circuit breaker and on the input terminal of the second circuit breaker drops below a predetermined threshold voltage; and
to switch the first circuit breaker into the diode state thereof and the second circuit breaker into the conductor state thereof in a power supply operating state.

9. An on-board electrical system in accordance with claim 2, further comprising a starter connected to the first constant voltage source and connected to the first breaker input terminal.

10. An on-board electrical system in accordance with claim 2, further comprising an actuating device switching over the first circuit breaker and the second circuit breaker between the conductor state and the diode state, said actuating device being configured to switch the first circuit breaker into the diode state thereof in an operating state of the starter for starting an internal combustion engine.

11. An on-board electrical system in accordance with claim 2, further comprising an alternator connected to the output terminal of the first circuit breaker and connected to the output terminal of the second circuit breaker.

12. An on-board electrical system in accordance with claim 2, further comprising a group of electrical energy consumers connected to the output terminal of the first circuit breaker and connected to the output terminal of the second circuit breaker.

13. An on-board electrical system in accordance with claim 2, further comprising a group of electrical energy consumers connected to the second constant voltage source and to the input terminal of the second circuit breaker.

14. An on-board electrical system in accordance with claim 1, further comprising an actuating device switching over the first circuit breaker and the second circuit breaker between the conductor state and the diode state, said actuating device being configured to switch the first circuit breaker into the diode state thereof in a starter operating state for starting an internal combustion engine.

15. An on-board electrical system in accordance with claim 1, further comprising an actuating device switching over the first circuit breaker and the second circuit breaker between the conductor state and the diode state, said actuating device being configured to switch the first circuit breaker into the diode state thereof in a parking operating state.

16. An on-board electrical system in accordance with claim 1, further comprising an actuating device switching over the first circuit breaker and the second circuit breaker between the conductor state and the diode state, said actuating device being configured to switch the first circuit breaker into the conductor state thereof and the second circuit breaker into the diode state thereof in a charging operating state for the first constant voltage source.

17. An on-board electrical system in accordance with claim 1, further comprising an actuating device switching over the first circuit breaker and the second circuit breaker between the conductor state and the diode state, said actuating device being configured to switch the first circuit breaker into the diode state thereof when the first constant voltage source reaches a predetermined state of charge.

18. An on-board electrical system in accordance with claim 1, further comprising an actuating device switching over the first circuit breaker and the second circuit breaker between the conductor state and the diode state, said actuating device being configured to switch the second circuit breaker into the diode state thereof when the voltage on the output terminal of the second circuit breaker drops below a predetermined threshold voltage.

19. An on-board electrical system in accordance with claim 1, further comprising an actuating device switching over the first circuit breaker and the second circuit breaker between the conductor state and the diode state, said actuating device being configured to switch the second circuit breaker into the diode state thereof when the voltage on the input terminal of the second circuit breaker drops below a predetermined threshold voltage.

20. An on-board electrical system in accordance with claim 1, further comprising an actuating device switching over the first circuit breaker and the second circuit breaker between the conductor state and the diode state, said actuating device being configured to switch the first circuit breaker into the diode state thereof and the second circuit breaker into the conductor state thereof in a power supply operating state.
